(19) United States
(12) Patent Application Publication
(10) Pub. No.: US 2019/0360610 A1
(43) Pub. Date: Nov. 28, 2019

(54) VERTICAL LOCKING DEVICE FOR KNOBS OF APPARATUSES USING FUEL GAS

(71) Applicant: Universidad Nacional de Itapua, Encarnacion (PY)

(72) Inventors: Fernando Luis GALEANO FLORES, Hohenau - Itapua (PY); Waldy Anibal RIVEROS SAAVEDRA, Pilar Neembucu (PY); Ricardo Hideto MATSUNAGA MASAOKA, La Paz - Itapua (PY); Sandra Isabel KALLUS LOBSIGER, Bella Vista - Itapua (PY); Rodney DELGADO, Cocle - Panama (PA)

(21) Appl. No.: 16/032,490

(22) Filed: Jul. 11, 2018

(30) Foreign Application Priority Data
May 25, 2018 (PY) P 1839502

(51) Int. Cl. F16K 35/10; F24C 3/12; F24C 15/36

(52) U.S. Cl. CPC F16K 35/10; F24C 3/124; F24C 3/126; F24C 3/122; F24C 15/36

(57) ABSTRACT

The present invention seeks to provide a device made of relatively simple mechanical elements, intended to lock and unlock the knobs used for opening the flow of gas for stoves, heaters or similar equipment, which is used as a safety system to prevent accidental intoxication, explosions or fires. The device of the invention basically consists of a main rod, made of metal or any other type of resistant material, the movement of which releases or presses the knobs, preventing the rotation thereof and the subsequent flow of gas, which also has springs that have the function of pressing the main rod and maintaining it in the locked position; since the rod of the knob controlling the flow of gas is designed to act with the locking tabs of the main rod, until a cord, made of metal or another resistant material, pulls the main rod, sliding over a fixed pulley, when the actuating knob is located in the unlocked position, said knob has an interlock, preventing a possible locking while the stove, heater or similar equipment is functioning in a normal manner.

### CROSS REFERENCE TO RELATED APPLICATION

This application claims priority of Paraguay Application No. P 1839502 PY filed May 25, 2018, application which is incorporated herein by reference.

### FIELD OF THE INVENTION

The present invention can be included in the technical field of industrial and home safety, in particular, that which is related to accidental intoxication, explosions and fires caused by gas leaks in equipment that uses gas as a fuel for heating a home or building, heating or cooking food, and other uses. More specifically, the object of the invention relates to a device for achieving a vertical locking of knobs of stoves or said equipment that uses gas as a fuel, as was previously mentioned.

More specifically, the present invention is related to a device made of relatively simple mechanical elements, intended to lock and unlock the knobs for opening the flow of gas for stoves, heaters or similar equipment, which is used as a safety system to prevent accidental intoxication, explosions or fires. The device basically consists of a main rod, made of metal or any other resistant material, the movement of which releases or presses the knobs, preventing them from rotating and, therefor, the subsequent flow of gas. The device has springs that have the function of pressing the main rod and maintaining it in the locked position, due to the fact that the shaft of the knob controlling the flow of gas is designed to act with the locking tabs of the main rod, until a cord, made of metal or another resistant material, pulls the main rod, sliding over a fixed pulley, and when the actuating knob is located in the unlocked position, said knob has an interlock, preventing it from a possible locking while the stove, heater or similar equipment is functioning in a normal manner.

### BACKGROUND OF THE INVENTION

Nowadays, there are many accidents that happen which are related to gas leaks in stoves or apparatuses that use gas as a fuel, and the majority of these accidents happen due to neglect by users or people who unintentionally manipulate the knobs or valves that control the flow of gas coming from the supply to the burner. This problem becomes significantly more serious when the gas leaks happen in homes, since in the majority of homes there are children who could manipulate the knobs and cause a gas leak without an adult present to notice the problem when it happens.

Therefore, there are times when it is necessary to ensure that the knobs that open the gas flow in stoves or heaters are closed or locked to prevent them from accidentally being opened, which could lead to an explosion and subsequently to a fire, in addition to intoxication of people in the home. One likely case is the accidental manipulation of the knobs by children, who leave them open, causing a gas leak that could have catastrophic consequences, leading to the death of people in some cases.

This being the case, in the state of the art there is a plurality of disclosures related to devices or systems for estimating or measuring corporal variables of a user, such as document KR 484929, which defines a flow structure of a valve for a heater, which has a body provided with an inlet, such that fuel gas is injected when a safety system is arranged on an inner side of the main body. Likewise, a central passage is formed on the inner side of the main body, and forms a trajectory for the flow of fuel gas. A gas passage is connected to the central passage, and a knob shaft is also arranged on the main body, where said knob opens the safety system to inject fuel gas into the inlet and gas outlet of the main body through the safety system.

On the other hand, we may consider document CA 2909321, which discloses a gas appliance, such as a heater, which has an electromagnetic unit magnetically associated with a movable assembly, which allows a change in the position of the movable assembly as it receives electrical pulses. A shut-off valve comprises a manual actuator for moving the movable assembly, along with a closure member to open or close the gas flow. The manual actuator comprises an open position in which it is decoupled from the movable assembly, the electromagnetic actuator thus being able to act on the closure member to cause its closure.

Likewise, we may also examine document WO 2005096695, which teaches a storage system for hazardous gas using metal canisters, and which requires a valve assembly to safely control the delivery of gas to the application. The system comprises a shut-off valve assembly in series with the flow control valve, wherein said shut-off valve provides a secondary seal during the storage outside of the application system that reduces the risk of undesirable gas release and prevents access to the primary seal or flow control valve and thus prevents the tampering of the internal mechanism and thereby avoids safety hazards. The shut-off valve is preferably opened by a pin that depresses a secondary seal stopper when the connection is made. The flow control valve is magnetically actuated by a magnetic flux generated by a coil. Thus, when an electric signal is sent to the coil, the armature is moved into the open position to open the primary seal, thereby allowing gas to flow through the valve into the application system.

Document KR 541721 may also be considered, which discloses a safety device for gas heaters for forcefully cutting the supply of gas after a set time by rotating an ignition lever or knob and controlling an original position through the operation of a motor, wherein the knob for igniting and controlling the gas device is rotated using the rotational energy of the motor and a gas barrier and configures the electronic valve, and the valve automatically blocks the interception valve and measures the control box controller and ignites the gas oven or stove.

On the other hand, we may refer to document U.S. Pat. No. 4,346,701, which corresponds to a gas administration apparatus that corresponds to a unit for administering gas for anesthesia and life support and only operates when positively locking the outlet of the gas supply, wherein said apparatus includes an interlock system which prevents a valve for controlling the admission to the unit of gas from a supply provided by the apparatus from being operated before a locking mechanism has locked the unit to the anesthesia machine. The interlock system also includes actuating means which when the unit is mounted on the anesthesia machine, opens respective valve members in ports located on the anesthesia machine only when the control valve is moved to its operating position.

There are also systems that use releasable locking knobs that prevent that a switch or valve from being turned on, but this system is complicated, using a lock that has a movable pin, as defined in document U.S. Pat. No. 5,771,878 by Lewis et al, from June of 1998.

On the other hand, there are disclosures of knobs that have valves with a thermoelectric security device, as defined in U.S. Pat. No. 6,886,581 by Harniet et al., from May of 2005, but it does not consider the locking of the knob, but rather reduces the size of these types of valves, improving the internal mechanism thereof.

According to the information provided in the preceding paragraphs, it is evident that current solutions disclose different mechanisms or devices for locking valves or knobs used in gas systems, however, none of said documents shows a main knob that has two tabs per knob that hold the shaft of the same when descending, and avoid the rotation of the same, wherein the rod at the middle longitudinal point thereof is joined to the unlocking knob by means of a cord, and is situated in the rear area of the stove, wherein the main rod with the tabs thereof prevents the movement from causing the rotation, since it is supported on the shaft of the rod by means of springs. Moreover, an unlocking knob that rotates on the shaft thereof, with the possibility of actuating the system and consisting of an interlock to prevent the knobs from locking when it is not necessary, is not disclosed.

Thus, it may be declared that in the state of the art there is a need to design and implement a device as an alternative for increasing the safety in the manipulation of gas in stoves, heaters and similar equipment, with a simple and entirely mechanical system, without electric or pneumatic parts, and without electronic controls that would increase the cost and complications of maintaining the equipment.

### SUMMARY OF THE INVENTION

The present invention seeks to provide a device made of rods, which are made of metal or any other resistant material, springs and a cord, made of metal or any other resistant material, intended to lock the rotating knobs used for allowing the flow of gas for stoves, heaters or similar equipment, which is used as a safety system to prevent accidental intoxication, explosions or fires.

Thus, the main object of the present invention is to increase the safety of the manipulation of gas in stoves and similar equipment by means of a simple and entirely mechanical system, without electric or pneumatic parts, and without electronic controls that would increase the cost and complications of maintaining the equipment.

This way, the device of the invention comprises a main rod which has two tabs per knob that hold the shaft of the same when descending and prevent the rotation of the same. At its middle longitudinal point, the rod is joined to the unlocking knob by means of a cord and is located in the rear area of the stove.

Thus, the main rod and the tabs thereof prevent the movement from causing the rotation, since it is supported on the shaft of the knob by means of springs. The unlocking knob rotates around its own shaft, with the possibility of actuating the system and consists of an interlock to prevent the knobs from locking when it is not necessary.

### BRIEF DESCRIPTION OF THE FIGURES

The present invention may be understood more clearly based on the following figures wherein the different components, parts or steps associated with the present device, apparatus, system or method are shown, as well as the novel elements with respect to the state of the art, wherein the figures do not aim to limit the scope of the invention, which is only determined by the attached claims, wherein:

FIG. 1 shows a front perspective view of the device of the present invention with the knobs for controlling the flow of gas in an unlocked position.

FIG. 2 shows a front perspective view of the device of the present invention with the knobs for controlling the flow of gas in a locked position.

FIG. 3 shows a perspective view of the knob for actuating the interlock system.

### DETAILED DESCRIPTION OF THE INVENTION

The previously described figures are not drawn to scale. The current dimensions of each of the components of the device can vary according to the user's needs. The most significant details of the device of the invention are highlighted for the purposes of providing a clear concept of the invention for a person who is not an expert in the field.

The present invention seeks to provide a device for vertically blocking the knobs of a cooking apparatus or an apparatus using gas as fuel, such as a heater, which is based on the use of pulleys and a respective an actuation line, which allows a main rod which has projections or locking elements that fit with the shaft of each gas-supplying knob to be elevated or lowered, wherein the rod is also actuated by means of the use of springs which push it downwards, thus ensuring the proper functioning of the device and locking said knobs. Thus, the device of the present invention comprises the following components and/or parts, wherein the function and interaction of each one of the same is defined below:
A main rod 1a which is located in the front part of the device and from which a plurality of tabs 1b extends, made up of two tabs that have an angle defined between the two, wherein the number of said tabs 1b directly depends on the amount of knobs to be controlled by the device;
Springs 2 located on top of the main rod 1a and connected to the same, wherein the springs 2 are in charge of exerting a downward force on said rod 1a, wherein the other end of the springs 2 is connected to the surface where the burners of the apparatus are located, meaning the heater or similar heating element;
One or more knobs 3a that rotate on the shaft thereof and control the flow of gas to the burners of the heating apparatus, wherein said one or more knobs 3a is located below a main rod 1a and, on the rear part thereof, have a knob shaft 3b, wherein said knob shaft 3b coincides with the tabs 1b in number and complements the shape of the same, with aim of being inserted therein;
A joining cord 4 which allows a connection to be created between the main rod 1a and the element that locks the operation of the heating apparatus, as will be defined below;
A pulley 5, through which the joining cord 4 passes and allows the connection to be created between the elements of the device of the present invention for locking the rotation of the knobs 3a; and
A locking knob or lever 6 located in the rear part of the apparatus and which is joined by means of the joining cord 4 and the pulley 5 to the main rod 1a.

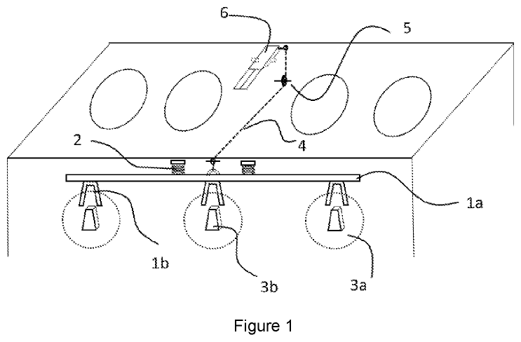

This being so, with regard to FIG. 1, said illustration corresponds to a front perspective view of the device in the unlocked position, wherein the main rod 1a is shown, which has a tab 1b made up of two projections per knob 3a, and the springs 2 are shown in their compressed configuration, in other words, they are directly pressed by the main rod 1a. Each knob of the stove 3a has a shaft 3b such that it coincides with the locking knobs 1b. In the same way, the joining cord 4, which slides on the pulley 5 is in charge of maintaining the main rod 1a in an unlocked position of the knob or lever 6 during normal use of the stove or heater, with the aim that the rod 1a does not come into contact with the knobs 3a or the shafts 3b thereof and therefore does not lock and the same can rotate freely with out restrictions to their use.

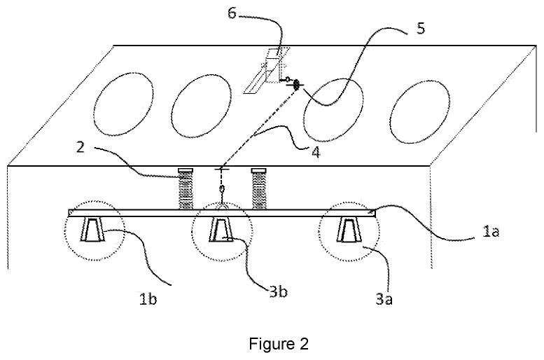

With regard to FIG. 2, said illustration corresponds to a front perspective view of the device, similar to the one shown in FIG. 1, but wherein the device is in the locking position, and wherein the actuation of the knob or lever 6 is shown, thus locking the movement of the knobs of the gas flow 3a, due to the fact that the springs 2 push the main rod 1a (by their nature) on the shaft 3b of the knob 3a of the stove or heater, restricting the possible rotation of said shaft 3b, by means of the opposition of the projections of each tab 1b.

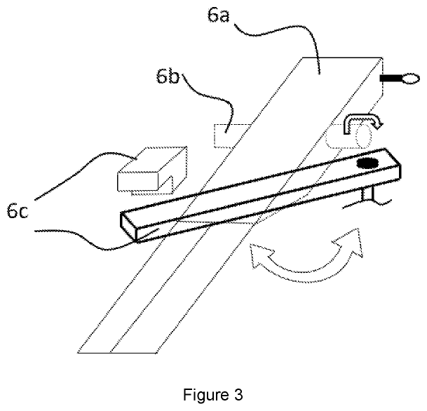

With regard to FIG. 3, this drawing corresponds to the interlocking 6c of the knob or actuating lever 6a that rotates on the shaft 6b thereof. This being so, this lever or knob 6a has the function of ensuring the locking or unlocking of the knobs 3a controlling the gas flow of the stove or heater, to maintain a normal functioning when it is necessary to heat the area or cook food. This way, when one wants to unlock the knobs 3a of the heating apparatus, one moves the actuating knob or lever 6a such that it is located completely horizontal, making it rotate on the shaft 6b thereof, and then said lever 6a is in the desired position, and it is then locked by means of the interlock 6c that corresponds to a pin that rotates on the horizontal plane and blocks or locks the detention element located at the end of the rotation when said pin is located directly on the actuation lever or knob 6a. Given that the actuating knob or lever 6a is connected at the rear end thereof by means of the cord 4 and the pulley 5 to the main rod 1a which is pushed by the springs 2, the natural movement of said actuating lever 6a is that of tilting towards the rear part, in other words, being pulled by the cord 4, which would take make it block the knobs 3a and, as a result, block the flow of gas towards the heating device (burners). Thus, the function of the interlock 6c is that of blocking said natural movement of the actuating knob or lever 6a, thereby achieving that the same does not move and allowing the device to be used without restrictions.

Thus, the movement of the interlock 6c to one side or the other, in other words blocking the actuation knob 6a or allowing it to move or tilt on the pivot point (shaft 6b), is done manually by the user, although in the present disclosure the movement of said actuating lever or knob 6a by any mechanical means, such as a motor or similar, is also envisaged.

1. A vertical locking device for knobs of gas apparatuses, comprising:
a main rod located in the front part of the device and which has one or more tabs;
one or more springs located on top of the main rod and connected to the same, wherein the other end of the springs is connected to the surface where the burners of the heating apparatus are located;
one or more knobs located below a main rod and which on the rear part thereof have a knob shaft on which they rotate, wherein said knob shaft coincides with the tabs in number and complements the shape of the same.
a joining cord which connects the main rod to the element that locks the operation of the heating apparatus;
a pulley through which the joining cord passes and creates the connection between the elements to lock the rotation of the knobs; and
a locking knob or lever located in the rear part of the apparatus and joined by means of the joining cord and the pulley to the main rod.

2. The locking device according to claim 1, wherein the number of tabs of the main rod coincide with the amount of knobs to control.

3. The locking device according to claim 1, wherein each one of the tabs is made up of two projections that form an angle between the same.

4. The locking device according to claim 1, wherein the locking lever or knob is made up of an actuating lever, a shaft on which the actuating lever rotates, and an interlock that rotates to place itself on the actuating lever, locking it.

5. The locking device according to claim 4, wherein the interlocking is made up of a pin that rotates on the horizontal plane, and a detention element located at the end of the rotation of said pin and which locks it when reaching the position thereof.
